(19) United States
(12) Patent Application Publication
(10) Pub. No.: US 2018/0133663 A1
(43) Pub. Date: May 17, 2018

(54) HIGH SELECTIVITY CHEMICALLY CROSS-LINKED RUBBERY MEMBRANES AND THEIR USE FOR SEPARATIONS

(71) Applicant: UOP LLC, Des Plaines, IL (US)

(72) Inventors: Chunqing Liu, Arlington Heights, IL (US); Nicole K. Karns, Des Plaines, IL (US); Deng-Yang Jan, Elk Grove Village, IL (US)

(21) Appl. No.: 15/685,931

(22) Filed: Aug. 24, 2017

Related U.S. Application Data
(60) Provisional application No. 62/423,636, filed on Nov. 17, 2016.

(51) Int. Cl. B01D 71/76; B01D 67/00; B01D 71/68; B01D 71/64; B01D 71/18

(52) U.S. Cl. CPC B01D 71/76; B01D 67/0006; B01D 71/18; B01D 71/64; B01D 71/68

(57) ABSTRACT

A novel chemically cross-linked rubbery polymeric thin film composite (TFC) membrane comprising a selective layer of a chemically cross-linked rubbery polymer supported by a porous support membrane formed from a glassy polymer has been developed. The chemically cross-linked rubbery polymeric thin film composite (TFC) membrane comprising a selective layer of a chemically cross-linked rubbery polymer supported by a porous support membrane formed from a glassy polymer may be used to separate at least one component from another.

### CROSS-REFERENCE TO RELATED APPLICATION

This application claims priority from Provisional Application No. 62/423,636 filed Nov. 17, 2016, the contents of which cited application are hereby incorporated by reference in its entirety.

### BACKGROUND OF THE INVENTION

Over 170 Honeywell UOP Separex™ membrane systems have been installed in the world for gas separation applications such as for the removal of acid gases from natural gas, in enhanced oil recovery, and hydrogen purification. Two new Separex™ membranes (Flux+ and Select) have been commercialized recently by Honeywell UOP, Des Plaines, Ill. for carbon dioxide (CO₂) removal from natural gas. These Separex™ spiral wound membrane systems currently hold the membrane market leadership for natural gas upgrading. These membranes prepared from glassy polymers, however, do not have outstanding performance for organic vapor separations such as for olefin recovery, liquefied petroleum gas (LPG) recovery, fuel gas conditioning, natural gas dew point control, nitrogen removal from natural gas, etc.

Polymeric membrane materials have been found to be of use in gas separations. Numerous research articles and patents describe glassy polymeric membrane materials (e.g., polyimides, polysulfones, polycarbonates, polyamides, polyarylates, polypyrrolones) with desirable gas separation properties, particularly for use in oxygen/nitrogen separation (see, for example, U.S. Pat. No. 6,932,589). The polymeric membrane materials are typically used in processes in which a feed gas mixture contacts the upstream side of the membrane, resulting in a permeate mixture on the downstream side of the membrane with a greater mole fraction of one of the components than the composition of the original feed gas mixture. A pressure differential is maintained between the upstream and downstream sides, providing the driving force for permeation. The downstream side can be maintained as a vacuum, or at any pressure below the upstream pressure.

The separation of a polymeric membrane is based on a solution-diffusion mechanism. This mechanism involves molecular-scale interactions of the permeating gas with the polymer. The mechanism assumes that in a membrane having two opposing surfaces, each component is sorbed by the membrane at one surface, transported by a gas concentration gradient, and desorbed at the opposing surface. According to this solution-diffusion model, the membrane performance in separating a given pair of gases (e.g., CO₂/CH₄, O₂/N₂, H₂/CH₄) is determined by two parameters: the permeability coefficient (abbreviated hereinafter as permeability or P_{A}) and the selectivity (α_{A/B}). The P_{A} is the product of the gas flux and the selective skin layer thickness of the membrane, divided by the pressure difference across the membrane. The α_{A/B} is the ratio of the permeability coefficients of the two gases (α_{A/B}=P_{A}/P_{B}) where P_{A} is the permeability of the more permeable gas and P_{B} is the permeability of the less permeable gas. Gases can have high permeability coefficients because of a high solubility coefficient, a high diffusion coefficient, or because both coefficients are high. In general, the diffusion coefficient decreases while the solubility coefficient increases with an increase in the molecular size of the gas. In high performance polymer membranes, both high permeability and selectivity are desirable because higher permeability decreases the size of the membrane area required to treat a given volume of gas, thereby decreasing capital cost of membrane units, and because higher selectivity results in a higher purity product gas.

The relative ability of a membrane to achieve the desired separation is referred to as the separation factor or selectivity for the given mixture. There are, however, several other obstacles to use a particular polymer to achieve a particular separation under any sort of large scale or commercial conditions. One such obstacle is permeation rate or flux. One of the components to be separated must have a sufficiently high permeation rate at the preferred conditions or extraordinarily large membrane surface areas are required to allow separation of large amounts of material. Therefore, commercially available glassy polymeric membranes, such as CA, polyimide, and polysulfone membranes formed by phase inversion and solvent exchange methods have an asymmetric integrally skinned membrane structure. See U.S. Pat. No. 3,133,132. Such membranes are characterized by a thin, dense, selectively semipermeable surface “skin” and a less dense void-containing (or porous), non-selective support region, with pore sizes ranging from large in the support region to very small proximate to the “skin”. Plasticization occurs when one or more of the components of the mixture act as a solvent in the polymer often causing it to swell and lose its membrane properties. It has been found that glassy polymers such as cellulose acetate and polyimides which have particularly good separation factors for separation of mixtures comprising carbon dioxide and methane are prone to plasticization over time thus resulting in decreasing performance of these membranes.

Natural gas often contains substantial amounts of heavy hydrocarbons and water, either as an entrained liquid, or in vapor form, which may lead to condensation within membrane modules. The gas separation capabilities of glassy polymeric membranes are affected when contacting with liquids including water and aromatic hydrocarbons such as benzene, toluene, ethylbenzene, and xylene (BTEX). The presence of more than modest levels of liquid BTEX heavy hydrocarbons is potentially damaging to traditional glassy polymeric membrane. Therefore, precautions must be taken to remove the entrained liquid water and heavy hydrocarbons upstream of the glassy polymeric membrane separation steps using expensive membrane pretreatment system. Another issue of glassy polymeric polymer membranes that still needs to be addressed for their use in gas separations in the presence of high concentration of condensable gas or vapor such as CO₂ and propylene is the plasticization of the glassy polymer by these condensable gases or vapors that leads to swelling of the membrane as well as a significant increase in the permeance of all components in the feed and a decrease in the selectivity of the membranes.

Some natural gas also contains substantial amount of nitrogen (N₂) in additional to the heavy hydrocarbons, water, and acid gases such as CO₂ and hydrogen sulfide (H₂S). Traditional glassy polymeric membranes are relatively more permeable to N₂ than to methane. These membranes, however, have low N₂ permeance and low N₂/CH₄ selectivity of <5.

For glassy polymeric gas separation membranes, permeant diffusion coefficient is more important than its solubility coefficient. Therefore, these glassy polymeric gas separation membranes preferentially permeate the smaller, less condensable gases, such as H₂ and CH₄ over the larger, more condensable gases, such as C₃H₈ and CO₂. On the other hand, in rubbery polymeric membranes such as polydimethylsiloxane membrane, permeant solubility coefficients are much more important than diffusion coefficient. Thus, these rubbery polymeric membranes preferentially permeate the larger, more condensable gases over the smaller, less condensable gases. PDMS is the most commonly used rubbery membrane material for separation of higher hydrocarbons or methane from permanent gases such as N₂ and H₂.

Most of the polyolefin such as polypropylene (PP) and polyethylene (PE) manufacturing plants and other polymer such as polyvinyl chloride (PVC) manufacturing plants use a degassing step to remove un-reacted olefins, solvents, and other additives from the raw polyolefin. Nitrogen is normally used as the stripping gas or for the polymer transfer. Disposing of the vent stream in a flare or partial recovery of the valuable olefin or other monomers via a condensing process results in the loss of valuable monomers and undesired emissions of the highly reactive volatile monomers into the air. Typically, the vent stream of the polymer reactor is compressed and then cooled to condense the monomers such as propylene and ethylene from the PP and PE reactors. The gas leaving the condenser still contains a significant amount of the monomers. One application for rubbery polymeric membranes is to recover the valuable monomers such as propylene, ethylene, and vinyl chloride and purify nitrogen for reuse from the vent stream. For olefin splitter overhead applications, the stream leaving the column overhead is primarily olefins, mixed with light gases such as N₂ or H₂. The membrane can separate the stream into an olefin-enriched stream and a light-gas-enriched stream. The olefin-enriched stream is returned to the distillation column, where the high value olefin is recovered, and the light-gas-enriched stream is vented or flared. The condensation/membrane hybrid process will achieve significantly higher olefin recovery than condensation process alone and also allows olefin recovery at moderate temperatures and pressures than condensation process. Ethylene recovery during the ethylene oxide (EO) production process to prevent the loss of valuable ethylene feedstock is another potential application of rubbery polymeric membranes. The rubbery polymeric membrane separates ethylene from argon purge gas by permeating ethylene at a much faster rate than argon to generate ethylene-enriched permeate that will be returned to the EO reactor and argon-enriched residue that will be flared.

The rubbery polymeric membrane can also be used for fuel gas conditioning that will reduce heavier hydrocarbons and increase CH₄ content (methane number) in the fuel gas which will be used to power upstream oil and gas operations while maintaining the pressure of the tail gas. Glassy polymeric membranes normally have very low methane permeance and also relatively low methane/heavy hydrocarbon selectivities.

### SUMMARY OF THE INVENTION

This invention discloses a new type of chemically cross-linked rubbery polymeric thin film composite (TFC) membrane comprising a thin selective layer of a chemically cross-linked rubbery polymer on top of a porous support membrane formed from a glassy polymer such as polyethersulfone (PES), polysulfone (PSF), polyimide (PI), a blend of PES and PI, a blend of PSF and PI, and a blend of cellulose acetate (CA) and cellulose triacetate (CTA), wherein said chemically cross-linked rubbery polymer is formed from chemical cross-linking between an isocyanate functional polysiloxane and an amino functional cross-linking agent, an epoxy functional polysiloxane and an amino functional cross-linking agent, or an amino functional polysiloxane and an isocyanate functional cross-linking agent. The present invention also discloses a method of making such a new type of chemically cross-linked rubbery polymeric thin film composite (TFC) membrane, and the use of such a membrane for olefin recovery from polyolefin production process, LPG recovery, fuel gas conditioning, natural gas dew point control, and nitrogen removal from natural gas.

Different from glassy polymeric membranes that are highly selective to gases with smaller kinetic diameters over larger diameter gases, the new chemically cross-linked rubbery polymeric TFC membrane comprising a thin selective layer of a chemically cross-linked rubbery polymer on top of a porous support membrane formed from a glassy polymer disclosed in the present invention is highly selective to olefins and heavier hydrocarbons over methane and inert gases such as N₂ and H₂. In addition, opposite from glassy polymeric membranes, the new chemically cross-linked rubbery polymeric TFC membrane described in the current invention has improved permeance and selectivity with the increase of operating time due to the increase of plasticization of condensable olefins on the membrane or with the decrease of operating temperature.

The porous support membrane formed from a glassy polymer such as PES, PSF, PI, a blend of PES and PI, a blend of PSF and PI, and a blend of CA and CTA used for the preparation of the new chemically cross-linked rubbery polymeric TFC membrane disclosed in the present invention is fabricated using a phase inversion process by casting the glassy polymer solution using a casting knife. The porous support membrane can be either a flat sheet support membrane or a hollow fiber support membrane. The solvents used for dissolving the glassy polymer material for the preparation of the porous support membrane are chosen primarily for their ability to completely dissolve the polymers, ease of solvent removal in the membrane formation steps, and their function for the formation of pores on the skin layer of the support membrane. Other considerations in the selection of solvents include low toxicity, low corrosive activity, low environmental hazard potential, availability and cost. Representative solvents include most amide solvents that are typically used for the formation of the very small pore, nanoporous support membrane, such as N-methylpyrrolidone (NMP) and N,N-dimethyl acetamide (DMAc), methylene chloride, tetrahydrofuran (THF), acetone, methyl acetate, isopropanol, n-octane, n-hexane, n-decane, methanol, ethanol, N,N-dimethylformamide (DMF), dimethyl sulfoxide (DMSO), lactic acid, citric acid, dioxanes, 1,3-dioxolane, glycerol, mixtures thereof, others known to those skilled in the art and mixtures thereof. Preferably, the solvents used for dissolving the glassy polymer material for the preparation of the porous support membrane in the current invention include NMP, 1,3-dioxolane, glycerol, and n-decane.

The thin selective layer of a chemically cross-linked rubbery polymer is formed on top of the porous support membrane by applying a dilute hydrocarbon solution of a mixture of an isocyanate functional polysiloxane and an amino functional cross-linking agent, or an epoxy functional polysiloxane and an amino functional cross-linking agent, or an amino functional polysiloxane and an isocyanate functional cross-linking agent to the top surface of the porous support membrane by dip-coating, spin coating, casting, soaking, spraying, painting, and other known conventional solution coating technologies. The thin selective layer of the chemically cross-linked rubbery polymer is formed by chemical cross-linking between the isocyanate functional polysiloxane and the amino functional cross-linking agent, or the epoxy functional polysiloxane and the amino functional cross-linking agent, or the amino functional polysiloxane and the isocyanate functional cross-linking agent after evaporating the hydrocarbon organic solvent(s) and heating at 70-150° C. for a certain time.

Permeation experimental results demonstrate that the new chemically cross-linked rubbery polymeric TFC membrane comprising a thin selective layer of a chemically cross-linked rubbery polymer on top of a porous support membrane disclosed in the present invention has higher permeance for paraffins such as ethane, propane, n-butane, and olefins such as propylene, n-butene, ethylene than inert gases such as N₂ and H₂ as well as CH₄ and has significantly higher α_{C3=/N2} (45-51), α_{C3/N2} (52-60), α_{C3=/H2} (22-25), and α_{C3/C1} (3.9) than thermally cross-linked RTV615A/B silicone rubber membrane and UV cross-linked epoxysilicone rubbery membrane for olefin and N₂ recovery, LPG recovery, and fuel gas conditioning applications.

This invention discloses the use of single stage or multi-stage new chemically cross-linked rubbery polymeric TFC membrane comprising a thin selective layer of a chemically cross-linked rubbery polymer on top of a porous support membrane described in the current invention for olefin recovery, LPG recovery, fuel gas conditioning, natural gas dew point control, nitrogen removal from natural gas, etc. This invention also discloses the use of new chemically cross-linked rubbery polymeric TFC membrane comprising a thin selective layer of a chemically cross-linked rubbery polymer on top of a porous support membrane described in the current invention together with a high performance Separex glassy polymeric membrane in a multi-stage membrane system for olefin recovery, LPG recovery, fuel gas conditioning, natural gas dew point control, nitrogen removal from natural gas, etc.

### DETAILED DESCRIPTION OF THE INVENTION

Membrane technology has been of great interest for the separation of gas, vapor, and liquid mixtures. However, despite significant research effort on separations by membrane technology, relatively low selectivity is still a remaining issue for rubbery polymeric membranes for separations such as for olefin recovery, LPG recovery, fuel gas conditioning, natural gas dew point control, and nitrogen removal from natural gas.

This invention discloses a new type of chemically cross-linked rubbery polymeric thin film composite (TFC) membrane comprising a thin selective layer of a chemically cross-linked rubbery polymer on top of a porous support membrane formed from a glassy polymer such as polyethersulfone (PES), polysulfone (PSF), polyimide (PI), a blend of PES and PI, a blend of PSF and PI, and a blend of cellulose acetate (CA) and cellulose triacetate (CTA), wherein said chemically cross-linked rubbery polymer is formed from chemical cross-linking between an isocyanate functional polysiloxane and an amino functional cross-linking agent, an epoxy functional polysiloxane and an amino functional cross-linking agent, or an amino functional polysiloxane and an isocyanate functional cross-linking agent. The present invention also discloses a method of making such a new type of chemically cross-linked rubbery polymeric thin film composite (TFC) membrane, and the use of such a membrane for olefin recovery from polyolefin production process, LPG recovery, fuel gas conditioning, natural gas dew point control, and nitrogen removal from natural gas.

Different from glassy polymeric membranes that are highly selective to gases with smaller kinetic diameters over larger diameter gases, the new chemically cross-linked rubbery polymeric TFC membrane comprising a thin selective layer of a chemically cross-linked rubbery polymer on top of a porous support membrane formed from a glassy polymer disclosed in the present invention is highly selective to olefins and heavier hydrocarbons over methane and inert gases such as N₂ and H₂. In addition, opposite from glassy polymeric membranes, the new chemically cross-linked rubbery polymeric TFC membrane described in the current invention has improved permeance and selectivity with the increase of operating time due to the increase of plasticization of condensable olefins on the membrane or with the decrease of operating temperature.

The porous support membrane can be formed from any glassy polymer that has good film forming properties such as PES, PSF, PI, a blend of PES and PI, a blend of PSF and PI, and a blend of CA and CTA. The porous support membrane used for the preparation of the new chemically cross-linked rubbery polymeric TFC membrane disclosed in the present invention is fabricated using a phase inversion process by casting the glassy polymer solution using a casting knife. The porous support membrane described in the current invention can be either asymmetric integrally skinned membrane or TFC membrane with either flat sheet (spiral wound) or hollow fiber geometry.

The current invention discloses the use of a porous support membrane for the preparation of the new chemically cross-linked rubbery polymeric TFC membrane by coating a thin selective layer of a chemically cross-linked rubbery polymer on top of the porous support membrane. The porous support membrane for the preparation of the new chemically cross-linked rubbery polymeric TFC membrane described in the present invention has a carbon dioxide permeance of at least 100 GPU and no carbon dioxide/methane selectivity at 50° C. under 30-100 psig 10% CO₂/90% CH₄ mixed gas feed pressure.

The solvents used for dissolving the glassy polymer material for the preparation of the porous support membrane are chosen primarily for their ability to completely dissolve the polymers, ease of solvent removal in the membrane formation steps, and their function for the formation of small pores on the skin layer of the support membrane. Other considerations in the selection of solvents include low toxicity, low corrosive activity, low environmental hazard potential, availability and cost. Representative solvents include most amide solvents that are typically used for the formation of the porous support membrane, such as N-methylpyrrolidone (NMP) and N,N-dimethyl acetamide (DMAc), methylene chloride, tetrahydrofuran (THF), acetone, methyl acetate, isopropanol, n-octane, n-hexane, n-decane, methanol, ethanol, N,N-dimethylformamide (DMF), dimethyl sulfoxide (DMSO), lactic acid, citric acid, dioxanes, 1,3-dioxolane, glycerol, mixtures thereof, others known to those skilled in the art and mixtures thereof. Preferably, the solvents used for dissolving the glassy polymer material for the preparation of the porous support membrane in the current invention include NMP, 1,3-dioxolane, glycerol, and n-decane.

The thin selective layer of the chemically cross-linked rubbery polymer described in the present invention is formed on top of the porous support membrane by applying a dilute solution of a mixture of an isocyanate functional polysiloxane and an amino functional cross-linking agent, or an epoxy functional polysiloxane and an amino functional cross-linking agent, or an amino functional polysiloxane and an isocyanate functional cross-linking agent to the top surface of the porous support membrane by dip-coating, spin coating, casting, soaking, spraying, painting, and other known conventional solution coating technologies. The thin selective layer of the chemically cross-linked rubbery polymer is formed by chemical cross-linking between the isocyanate functional polysiloxane and the amino functional cross-linking agent, or the epoxy functional polysiloxane and the amino functional cross-linking agent, or the amino functional polysiloxane and the isocyanate functional cross-linking agent after evaporating the hydrocarbon organic solvent(s) and heating at 70-150° C. for a certain time.

The isocyanate functional polysiloxane used for the preparation of the new chemically cross-linked rubbery polymeric TFC membrane in the present invention is isocyanate-terminated polyorganosiloxanes such as isocyanate-terminated polydimethylsiloxane.

The amine functional polysiloxane used for the preparation of the new chemically cross-linked rubbery polymeric TFC membrane in the present invention can be selected from amine-terminated polyorganosiloxane, aminoorganomethylsiloxane-dimethylsiloxane copolymer, or a mixture thereof. An example of the amine-terminated polyorganosiloxane is aminopropyl-terminated polydimethylsiloxane as shown in formula (I)

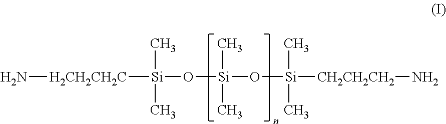

wherein n is an integer from 10 to 1000. The aminoorganomethylsiloxane-dimethylsiloxane copolymer comprises a plurality of a repeating units of formula (II)

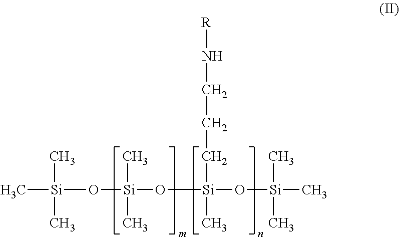

wherein —R is —H or —CH₂CH₂NH₂, wherein n and m are independent integers from 2 to 1000 and the molar ratio of n to m is in a range of 1:500 to 1:5.

The epoxy functional polysiloxane used for the preparation of the new chemically cross-linked rubbery polymeric TFC membrane in the present invention can be selected from epoxy-terminated polyorganosiloxane, epoxycyclohexylmethylsiloxane-dimethylsiloxane copolymer, or a mixture thereof. An example of the epoxy-terminated polyorganosiloxane is epoxypropoxypropyl-terminated polydimethylsiloxane as shown in formula (III)

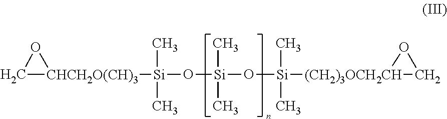

wherein n is an integer from 0 to 500. The epoxycyclohexylmethylsiloxane-dimethylsiloxane copolymer comprises a plurality of a repeating units of formula (IV)

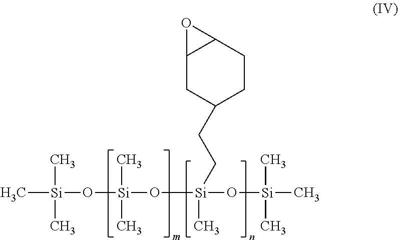

wherein n and m are independent integers from 2 to 1000 and the molar ratio of n to m is in a range of 1:500 to 1:5.

The amino functional cross-linking agent that will chemically cross-link with either the epoxy functional polysiloxane or the isocyanate functional polysiloxane for the formation of the new chemically cross-linked rubbery polymeric TFC membrane in the present invention is selected from said amine functional polysiloxanes or diamino organo silicone such as bis(3-aminopropyl)-tetramethyldisiloxane.

The isocyanate functional cross-linking agent that will chemically cross-link with amine functional polysiloxane for the formation of the new chemically cross-linked rubbery polymeric TFC membrane in the present invention can be selected from said isocyanate-terminated polyorganosiloxanes such as isocyanate-terminated polydimethylsiloxane, tolylene-2,4-diisothiocyanate, tolylene-2,6-diisothiocyanate, tolylene-2,4-diisocyanate, tolylene-2,5-diisocyanate, tolylene-2,6-diisocyanate, tolylene-α,4-diisocyanate, 4,4′-methylenebis(phenyl isocyanate), 1,3-phenylene diisocyanate, hexamethylene diisocyanate, 1,4-phenylene diisocyanate, or mixtures thereof.

The organic solvents that can be used for dissolving the isocyanate functional polysiloxane, the amino functional cross-linking agent, the epoxy functional polysiloxane, the amino functional polysiloxane and the isocyanate functional cross-linking agent in the present invention are essentially hydrocarbons such as n-heptane, n-hexane, n-octane, or mixtures thereof. It is preferred that these polyorganosiloxanes and cross-linking agents are diluted in the hydrocarbon organic solvent or mixtures thereof in a concentration of from about 1 to about 20 wt % to provide a defect-free thin chemically cross-linked rubbery polymer selective layer.

The present invention also discloses a method of making the new chemically cross-linked rubbery polymeric TFC membrane comprising a thin selective layer of a chemically cross-linked rubbery polymer on top of a porous support membrane comprising: a) preparation of a porous support membrane from a glassy polymer such as polyethersulfone (PES), polysulfone (PSF), polyimide (PI), a blend of PES and PI, a blend of PSF and PI, and a blend of cellulose acetate (CA) and cellulose triacetate (CTA) via a phase inversion membrane fabrication process; b) coating a thin layer of a dilute hydrocarbon solution of a mixture of an isocyanate functional polysiloxane and an amino functional cross-linking agent, or a mixture of an epoxy functional polysiloxane and an amino functional cross-linking agent, or a mixture of an amino functional polysiloxane and an isocyanate functional cross-linking agent to the top surface of the porous support membrane by dip-coating, spin coating, casting, soaking, spraying, painting, and other known conventional solution coating technologies; c) evaporating the hydrocarbon organic solvents on said membrane and heating the coated membrane at 70-150° C. for a certain time, and the thin selective layer of the chemically cross-linked rubbery polymer is formed by chemical cross-linking between the isocyanate functional polysiloxane and the amino functional cross-linking agent, or between the epoxy functional polysiloxane and the amino functional cross-linking agent, or between the amino functional polysiloxane and the isocyanate functional cross-linking agent.

The new type of chemically cross-linked rubbery polymeric TFC membrane comprising a thin selective layer of a chemically cross-linked rubbery polymer on top of a porous support membrane described in the present invention can be fabricated into any convenient form suitable for a desired separation application. For example, the membranes can be in the form of hollow fibers, tubes, flat sheets, and the like. The new chemically cross-linked rubbery polymeric TFC membrane comprising a thin selective layer of a chemically cross-linked rubbery polymer on top of a porous support membrane in the present invention can be assembled in a separator in any suitable configuration for the form of the membrane and the separator may provide for co-current, counter-current, or cross-current flows of the feed on the retentate and permeate sides of the membrane. In one exemplary embodiment, the new chemically cross-linked rubbery polymeric TFC membrane comprising a thin selective layer of a chemically cross-linked rubbery polymer on top of a porous support membrane described in the present invention is in a spiral wound module that is in the form of flat sheet having a thickness from about 30 to about 400 μm. In another exemplary embodiment, the new chemically cross-linked rubbery polymeric TFC membrane comprising a thin selective layer of a chemically cross-linked rubbery polymer on top of a porous support membrane described in the present invention is in a hollow fiber module that is in the form of thousands, tens of thousands, hundreds of thousands, or more, of parallel, closely-packed hollow fibers or tubes. In one embodiment, each fiber has an outside diameter of from about 200 micrometers (μm) to about 700 millimeters (mm) and a wall thickness of from about 30 to about 200 μm. In operation, a feed contacts a first surface of said chemically cross-linked rubbery polymeric TFC membrane comprising a thin selective layer of a chemically cross-linked rubbery polymer on top of a porous support membrane described in the present invention, a permeate permeates said membrane described in the present invention and is removed therefrom, and a retentate, not having permeated said membrane described in the present invention, also is removed therefrom. In another embodiment, the chemically cross-linked rubbery polymeric TFC membrane comprising a thin selective layer of a chemically cross-linked rubbery polymer on top of a porous support membrane described in the present invention can be in the form of flat sheet having a thickness in the range of from about 30 to about 400 μm.

The new chemically cross-linked rubbery polymeric TFC membrane comprising a thin selective layer of a chemically cross-linked rubbery polymer on top of a porous support membrane disclosed in the present invention has higher permeance for paraffins such as ethane, propane, n-butane, and olefins such as propylene, n-butene, ethylene than inert gases such as N₂ and H₂ as well as CH₄ and has significantly higher selectivities for olefin/nitrogen, hydrocarbon/nitrogen, olefin/hydrogen, hydrocarbon/hydrogen, and C2+ hydrocarbon/methane than thermally cross-linked RTV615A/B silicone rubber membrane and UV cross-linked epoxysilicone rubbery membrane for olefin and N₂ recovery, LPG recovery, and fuel gas conditioning applications (see Tables 1, 2, 3).

This invention discloses the use of single stage or multi-stage new chemically cross-linked rubbery polymeric TFC membrane comprising a thin selective layer of a chemically cross-linked rubbery polymer on top of a porous support membrane described in the current invention for olefin recovery, LPG recovery, fuel gas conditioning, natural gas dew point control, nitrogen removal from natural gas, etc. This invention also discloses the use of new chemically cross-linked rubbery polymeric TFC membrane comprising a thin selective layer of a chemically cross-linked rubbery polymer on top of a porous support membrane described in the current invention together with a high performance Separex glassy polymeric membrane in a multi-stage membrane system for olefin recovery, LPG recovery, fuel gas conditioning, natural gas dew point control, nitrogen removal from natural gas, etc.

### EXAMPLES

The following examples are provided to illustrate one or more preferred embodiments of the invention, but are not limited embodiments thereof. Numerous variations can be made to the following examples that lie within the scope of the invention.

### Comparative Example 1

### Preparation of 5RTVSi/PES-a TFC Membrane

A porous, asymmetric polyethersulfone (PES) gas separation support membrane was prepared via the phase-inversion process. A PES-a membrane casting dope comprising PES 18-25 wt %, NMP 60-65 wt %, 1,3-dioxolane 10-15 wt %, glycerol 1-10 wt % and n-decane 0.5-2 wt % was cast on a nylon fabric then gelled by immersion in a 1° C. water bath for about 10 minutes, and then annealed in a hot water bath at 85° C. for about 5 minutes. The wet membrane was dried at 70° C. The dried PES-a porous support membrane was coated with an RTVSi silicone rubber precursor polymer solution comprising RTV615A, RTV615B, and hexane (RTV615A:RTV615B=9:1 (weight ratio), 5 wt % of RTV615A+RTV615B in hexane) and then thermally cross-linked at 85° C. for 1 h to form a thin, nonporous, dense RTVSi selective layer on the surface of the PES-a support membrane (abbreviated as 5RTVSi/PES-a). The 5RTVSi/PES-a TFC membrane was tested with a fuel gas mixture of 70% C1, 15% C2, 10% C3 and 5% CO₂ at 3549 kPa (500 psig) and 25° C. The membrane was also tested with N₂, H₂, CH₄, propylene, and propane single gases at 791 kPa (100 psig) and 25° C.

### Example 1

### Preparation of 5DMS-TDI/PES-a TFC Membrane

A porous, asymmetric PES gas separation support membrane was prepared via the phase-inversion process. A PES-a membrane casting dope comprising PES 18-25 wt %, NMP 60-65 wt %, 1,3-dioxolane 10-15 wt %, glycerol 1-10 wt % and n-decane 0.5-2 wt % was cast on a nylon fabric then gelled by immersion in a 1° C. water bath for about 10 minutes, and then annealed in a hot water bath at 85° C. for about 5 minutes. The wet membrane was dried at 70° C. A 5 wt % DMS-TDI pre-cross-linked rubbery polymer solution was prepared by dissolving 6.0 g of an aminopropyl-terminated polydimethylsiloxane (Gelest catalog number: DMS-A21) and 0.25 g of 2,4-toluene diisocyanate (TDI) in 118.8 g of hexane at room temperature for about 10 min. The dried PES-a porous support membrane was coated with the 5 wt % DMS-TDI pre-cross-linked rubbery polymer solution, dried at room temperature for about 5 min, and then heated at 85° C. for 2 h to form a thin, nonporous, dense, chemically cross-linked DMS-TDI selective layer on the surface of the PES-a support membrane (abbreviated as 5DMS-TDI/PES-a). The 5DMS-TDI/PES-a TFC membrane was tested with a fuel gas mixture of 70% C1, 15% C2, 10% C3 and 5% CO₂ at 3549 kPa (500 psig) and 25° C. The membrane was also tested with N₂, H₂, CH₄, propylene, and propane single gases at 791 kPa (100 psig) and 25° C. The membrane permeances (P/L) and selectivities (α) are shown in Tables 1, 2, and 3.

### Example 2

### Preparation of 6.5DMS-TDI/PES-a TFC Membrane

A 6.5DMS-TDI/PES-a TFC membrane was prepared using the procedure described in Example 1 except that the PES-a support membrane was coated with a 6.5 wt % DMS-TDI pre-cross-linked rubbery polymer solution comprising 6.0 g of DMS-A21 and 0.25 g of 2,4-toluene diisocyanate (TDI) in 89.9 g of hexane at room temperature for about 10 min. The coated membrane was dried at room temperature for about 5 min, and then heated at 85° C. for 2 h to form a thin, nonporous, dense, chemically cross-linked DMS-TDI selective layer on the surface of the PES-a support membrane (abbreviated as 6.5DMS-TDI/PES-a). The 6.5DMS-TDI/PES-a TFC membrane was tested with a fuel gas mixture of 70% C1, 15% C2, 10% C3 and 5% CO₂ at 3549 kPa (500 psig) and 25° C. The membrane was also tested with N₂, H₂, CH₄, propylene, and propane single gases at 791 kPa (100 psig) and 25° C. The membrane permeances (P/L) and selectivities (α) are shown in Tables 1 and 2.

### Example 3

### Preparation of 5DMS-TDI/5DMS-TDI/PES-a Dual-Coated TFC Membrane

A 5DMS-TDI/5DMS-TDI/PES-a dual-coated TFC membrane was prepared using the procedure described in Example 1 except that the PES-a support membrane was first coated with a 5 wt % DMS-TDI pre-cross-linked rubbery polymer solution comprising 6.0 g of DMS-A21 and 0.25 g of 2,4-toluene diisocyanate (TDI) in 118.8 g of hexane at room temperature for about 10 min. The coated membrane was dried at room temperature for about 5 min, and then heated at 85° C. for 2 h to form the first layer of thin, nonporous, dense, chemically cross-linked DMS-TDI on the surface of the PES-a support membrane. The DMS-TDI-coated PES-a TFC membrane was then coated with a 5 wt % DMS-TDI pre-cross-linked rubbery polymer solution again, dried at room temperature for about 5 min, and then heated at 85° C. for 2 h to form the second layer of thin, nonporous, dense, chemically cross-linked DMS-TDI on the surface of the DMS-TDI-coated PES-a TFC membrane (abbreviated as 5DMS-TDI/5DMS-TDI/PES-a). The 5DMS-TDI/5DMS-TDI/PES-a dual-coated TFC membrane was tested with a fuel gas mixture of 70% C1, 15% C2, 10% C3 and 5% CO₂ at 3549 kPa (500 psig) and 25° C. The membrane was also tested with N₂, H₂, CH₄, propylene, and propane single gases at 791 kPa (100 psig) and 25° C. The membrane permeances (P/L) and selectivities (α) are shown in Tables 1, 2, and 3.

### Example 4

### Preparation of 5DMS-A-DMS-E/PES-a TFC Membrane

A 5DMS-A-DMS-E/PES-a TFC membrane was prepared using the PES-a support membrane same as that was used in Example 1. A 5 wt % DMS-A-DMS-E pre-cross-linked rubbery polymer solution was prepared by dissolving 3.0 g of an aminopropyl-terminated polydimethylsiloxane (Gelest catalog number: DMS-A21) and 4.5 g of epoxypropoxypropyl-terminated polydimethylsiloxane (Gelest catalog number: DMS-E21) in 142.5 g of hexane at room temperature for about 10 min. The dried PES-a porous support membrane was coated with the 5 wt % 5DMS-A-DMS-E pre-cross-linked rubbery polymer solution, dried at room temperature for about 5 min, and then heated at 85° C. for 2 h to form a thin, nonporous, dense, chemically cross-linked DMS-A-DMS-E selective layer on the surface of the PES-a support membrane (abbreviated as 5DMS-A-DMS-E/PES-a). The 5DMS-A-DMS-E/PES-a TFC membrane was tested with a fuel gas mixture of 70% C1, 15% C2, 10% C3 and 5% CO₂ at 3549 kPa (500 psig) and 25° C. The membrane was also tested with N₂, H₂, CH₄, propylene, and propane single gases at 791 kPa (100 psig) and 25° C. The membrane permeances (P/L) and selectivities (α) are shown in Tables 1 and 2.

TABLE 1
Pure gas permeation results for 5RTVSi/PES-a, 5DMS-TDI/PES-a,
6.5DMS-TDI/PES-a, and 5DMS-TDI/5DMS-TDI/PES-a TFC membranes
for propylene recovery (propylene (C_{3═})/N₂ and C_{3═}/H₂ separations)*

| Membrane | P_{C3═}/L (GPU) | α_{C3═/N2} | α_{C3═/H2} |
|---|---|---|---|
| 5RTVSi/PES-a | 2881 | 31.8 | 10.3 |
| 5DMS-TDI/PES-a | 1370 | 44.7 | 18.7 |
| 6.5DMS-TDI/PES-a | 1069 | 48.7 | 21.3 |
| 5DMS-TDI/5DMS-TDI/PES-a | 635 | 51.0 | 21.4 |
| 5DMS-A-DMS-E/PES-a | 2794 | 41.9 | 15.8 |

*Tested at room temperature and 791 kPa (100 psig); 1 GPU = 10⁻⁶ cm³(STP)/cm² · sec · cmHg

TABLE 2
Pure gas permeation results for 5RTVSi/PES-a, 5DMS-TDI/
PES-a, 6.5DMS-TDI/PES-a, and 5DMS-TDI/5DMS-TDI/PES-a
TFC membranes for liquid petroleum gas (LPG)
recovery (propane (C₃)/N₂ and C₃/H₂ separations)*

| Membrane | P_{C3}/L (GPU) | α_{C3/N2} | α_{C3/H2} |
|---|---|---|---|
| 5RTVSi/PES-a | 3093 | 34.2 | 11.1 |
| 5DMS-TDI/PES-a | 1588 | 51.8 | 21.7 |
| 6.5DMS-TDI/PES-a | 1180 | 53.7 | 23.5 |
| 5DMS-TDI/5DMS-TDI/PES-a | 740 | 59.5 | 25.0 |
| 5DMS-A-DMS-E/PES-a | 3380 | 50.7 | 19.2 |

*Tested at room temperature and 791 kPa (100 psig); 1 GPU = 10⁻⁶ cm³(STP)/cm² · sec · cmHg

TABLE 3
5DMS-TDI/PES-a and 5DMS-TDI/5DMS-TDI/PES-a TFC
membranes for fuel gas conditioning (separation of methane (CH₄)
from ethane (C₂), C₃, and C₃₊)*

| Membrane | P_{CH4}/L (GPU) | α_{C2/CH4} | α_{C3/CH4} |
|---|---|---|---|
| 5RTVSi/PES-a | 265 | 1.6 | 1.9 |
| 5DMS-TDI/PES-a | 170 | 2.2 | 3.1 |
| 5DMS-TDI/5DMS-TDI/PES-a | 69 | 2.5 | 3.9 |

*Tested at room temperature and 3549 kPa (500 psig) mixed gas comprising 70% CH₄, 15% C₂, 10% C₃, and 5% CO₂; 1 GPU = 10⁻⁶ cm³(STP)/cm² · sec · cmHg

### SPECIFIC EMBODIMENTS

While the following is described in conjunction with specific embodiments, it will be understood that this description is intended to illustrate and not limit the scope of the preceding description and the appended claims.

A first embodiment of the invention is a chemically cross-linked rubbery polymeric thin film composite (TFC) membrane comprising a selective layer of a chemically cross-linked rubbery polymer supported by a porous support membrane formed from a glassy polymer. An embodiment of the invention is one, any or all of prior embodiments in this paragraph up through the first embodiment in this paragraph wherein the glassy polymer is polyethersulfone (PES), polysulfone (PSF), polyimide (PI), a blend of PES and PI, a blend of PSF and PI, or a blend of cellulose acetate (CA) and cellulose triacetate (CTA). An embodiment of the invention is one, any or all of prior embodiments in this paragraph up through the first embodiment in this paragraph wherein the chemically cross-linked rubbery polymer is formed from chemical cross-linking between (a) an isocyanate functional polysiloxane and an amino functional cross-linking agent, or (b) an epoxy functional polysiloxane and an amino functional cross-linking agent, or (c) an amino functional polysiloxane and an isocyanate functional cross-linking agent. An embodiment of the invention is one, any or all of prior embodiments in this paragraph up through the first embodiment in this paragraph wherein (a) the isocyanate functional polysiloxane is an isocyanate-terminated polyorganosiloxanes; (b) the amine functional polysiloxane is an amine-terminated polyorganosiloxane, or an aminoorganomethylsiloxane-dimethylsiloxane copolymer, or a mixture thereof, (c) the epoxy functional polysiloxane is an epoxy-terminated polyorganosiloxane, or an epoxycyclohexylmethylsiloxane-dimethylsiloxane copolymer, or a mixture thereof; (d) the amino functional cross-linking agent is an amine functional polysiloxane; or diamino organo silicone; and (e) the isocyanate functional cross-linking agent is isocyanate-terminated polydimethylsiloxane, tolylene-2,4-diisothiocyanate, tolylene-2,6-diisothiocyanate, tolylene-2,4-diisocyanate, tolylene-2,5-diisocyanate, tolylene-2,6-diisocyanate, tolylene-α,4-diisocyanate, 4,4′-methylenebis(phenyl isocyanate), 1,3-phenylene diisocyanate, hexamethylene diisocyanate, 1,4-phenylene diisocyanate, or mixtures thereof. An embodiment of the invention is one, any or all of prior embodiments in this paragraph up through the first embodiment in this paragraph wherein the porous support membrane is a flat sheet support membrane or a hollow fiber support membrane. An embodiment of the invention is one, any or all of prior embodiments in this paragraph up through the first embodiment in this paragraph wherein the selective layer of a chemically cross-linked rubbery polymer is a flat sheet having a thickness from about 30 nm to about 40 μm. An embodiment of the invention is one, any or all of prior embodiments in this paragraph up through the first embodiment in this paragraph wherein the membrane is selective to olefins and ethane, propane, n-butane, and heavier than n-butane hydrocarbons over methane and inert gases. An embodiment of the invention is one, any or all of prior embodiments in this paragraph up through the first embodiment in this paragraph wherein the membrane has a higher permeance for ethane, propane, n-butane, propylene, n-butene, and ethylene than for N₂, H₂, and CH₄. An embodiment of the invention is one, any or all of prior embodiments in this paragraph up through the first embodiment in this paragraph wherein the chemically cross-linked rubbery polymeric thin film composite (TFC) membrane is in the form of hollow fibers, flat sheets, tubes.

A second embodiment of the invention is a method of making a chemically cross-linked rubbery polymeric thin film composite (TFC) membrane comprising a selective layer of a chemically cross-linked rubbery polymer supported by a porous support membrane formed from a glassy polymer, the method comprising (a) preparing the porous support membrane using a phase inversion process by casting a glassy polymer solution using a casting knife; (b) forming the chemically cross-linked rubbery polymer on the porous support membrane by (i) applying a dilute hydrocarbon solution of a mixture of a solvent, an isocyanate functional polysiloxane and an amino functional cross-linking agent, or a mixture of a solvent, an epoxy functional polysiloxane and an amino functional cross-linking agent, or a mixture of a solvent, an amino functional polysiloxane and an isocyanate functional cross-linking agent to the top surface of the porous support membrane; (ii) evaporating the solvent; and (iii) heating at 70-150° C. for a period of time. An embodiment of the invention is one, any or all of prior embodiments in this paragraph up through the second embodiment in this paragraph wherein the solvent is selected from the group consisting of n-heptane, n-hexane, n-octane, and mixtures thereof. An embodiment of the invention is one, any or all of prior embodiments in this paragraph up through the second embodiment in this paragraph wherein (a) the isocyanate functional polysiloxane is an isocyanate-terminated polyorganosiloxanes; (b) the amine functional polysiloxane is an amine-terminated polyorganosiloxane, or an aminoorganomethylsiloxane-dimethylsiloxane copolymer, or a mixture thereof; (c) the epoxy functional polysiloxane is an epoxy-terminated polyorganosiloxane, or an epoxycyclohexylmethylsiloxane-dimethylsiloxane copolymer, or a mixture thereof; (d) the amino functional cross-linking agent is an amine functional polysiloxane; or diamino organo silicone; and (e) the isocyanate functional cross-linking agent is isocyanate-terminated polydimethylsiloxane, tolylene-2,4-diisothiocyanate, tolylene-2,6-diisothiocyanate, tolylene-2,4-diisocyanate, tolylene-2,5-diisocyanate, tolylene-2,6-diisocyanate, tolylene-α,4-diisocyanate, 4,4′-methylenebis(phenyl isocyanate), 1,3-phenylene diisocyanate, hexamethylene diisocyanate, 1,4-phenylene diisocyanate, or mixtures thereof. An embodiment of the invention is one, any or all of prior embodiments in this paragraph up through the second embodiment in this paragraph wherein the isocyanate functional polysiloxane, the amino functional cross-linking agent, the epoxy functional polysiloxane, the amino functional polysiloxane, and the isocyanate functional cross-linking agent are diluted in a hydrocarbon organic solvent in a concentration of from about 1 to about 20 wt. %. An embodiment of the invention is one, any or all of prior embodiments in this paragraph up through the second embodiment in this paragraph wherein the glassy polymer solution comprises NMP, 1,3-dioxolane, glycerol, and n-decane. An embodiment of the invention is one, any or all of prior embodiments in this paragraph up through the second embodiment in this paragraph wherein the applying the dilute hydrocarbon solution to the top surface of the porous support membrane is by dip-coating, spin coating, casting, soaking, spraying, or painting. An embodiment of the invention is one, any or all of prior embodiments in this paragraph up through the second embodiment in this paragraph wherein the heating at 70-150° C. is for 2 min to 120 min.

A third embodiment of the invention is a process for removing at least one component from a stream comprising contracting the stream with a chemically cross-linked rubbery polymeric thin film composite (TFC) membrane comprising a selective layer of a chemically cross-linked rubbery polymer supported by a porous support membrane formed from a glassy polymer. An embodiment of the invention is one, any or all of prior embodiments in this paragraph up through the third embodiment in this paragraph wherein the at least one component is nitrogen, or hydrogen, or methane. An embodiment of the invention is one, any or all of prior embodiments in this paragraph up through the third embodiment in this paragraph wherein the stream is natural gas, fuel gas, an olefin recovery stream from a polyolefin production process, LPG, and a natural gas dew point control stream. An embodiment of the invention is one, any or all of prior embodiments in this paragraph up through the third embodiment in this paragraph wherein the process is a step of an olefin recovery operation, a nitrogen recovery operation, an LPG recovery operation, a fuel gas conditioning operation, or a nitrogen removal from natural gas operation. An embodiment of the invention is one, any or all of prior embodiments in this paragraph up through the third embodiment in this paragraph wherein the process is a two-stage process further comprising a glassy polymeric membrane.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A chemically cross-linked rubbery polymeric thin film composite (TFC) membrane comprising a selective layer of a chemically cross-linked rubbery polymer supported by a porous support membrane formed from a glassy polymer.

2. The chemically cross-linked rubbery polymeric thin film composite (TFC) membrane of claim 1 wherein the glassy polymer is polyethersulfone (PES), polysulfone (PSF), polyimide (PI), a blend of PES and PI, a blend of PSF and PI, or a blend of cellulose acetate (CA) and cellulose triacetate (CTA).

3. The chemically cross-linked rubbery polymeric thin film composite (TFC) membrane of claim 1 wherein the chemically cross-linked rubbery polymer is formed from chemical cross-linking between
(a) an isocyanate functional polysiloxane and an amino functional cross-linking agent, or
(b) an epoxy functional polysiloxane and an amino functional cross-linking agent, or
(c) an amino functional polysiloxane and an isocyanate functional cross-linking agent.

4. The chemically cross-linked rubbery polymeric thin film composite (TFC) membrane of claim 1 wherein
(a) the isocyanate functional polysiloxane is an isocyanate-terminated polyorganosiloxanes;
(b) the amine functional polysiloxane is an amine-terminated polyorganosiloxane, or an aminoorganomethylsiloxane-dimethylsiloxane copolymer, or a mixture thereof;
(c) the epoxy functional polysiloxane is an epoxy-terminated polyorganosiloxane, or an epoxycyclohexylmethylsiloxane-dimethylsiloxane copolymer, or a mixture thereof;
(d) the amino functional cross-linking agent is an amine functional polysiloxane; or diamino organo silicone; and
(e) the isocyanate functional cross-linking agent is isocyanate-terminated polydimethylsiloxane, tolylene-2,4-diisothiocyanate, tolylene-2,6-diisothiocyanate, tolylene-2,4-diisocyanate, tolylene-2,5-diisocyanate, tolylene-2,6-diisocyanate, tolylene-α,4-diisocyanate, 4,4′-methylenebis(phenyl isocyanate), 1,3-phenylene diisocyanate, hexamethylene diisocyanate, 1,4-phenylene diisocyanate, or mixtures thereof.

5. The chemically cross-linked rubbery polymeric thin film composite (TFC) membrane of claim 1 wherein the porous support membrane is a flat sheet support membrane or a hollow fiber support membrane.

6. The chemically cross-linked rubbery polymeric thin film composite (TFC) membrane of claim 1 wherein the selective layer of a chemically cross-linked rubbery polymer is a flat sheet having a thickness from about 30 nm to about 40 μm.

7. The chemically cross-linked rubbery polymeric thin film composite (TFC) membrane of claim 1 wherein the membrane is selective to olefins and ethane, propane, n-butane, and heavier than n-butane hydrocarbons over methane and inert gases.

8. The chemically cross-linked rubbery polymeric thin film composite (TFC) membrane of claim 1 wherein the membrane has a higher permeance for ethane, propane, n-butane, propylene, n-butene, and ethylene than for N₂, H₂, and CH₄.

9. The chemically cross-linked rubbery polymeric thin film composite (TFC) membrane of claim 1 wherein the chemically cross-linked rubbery polymeric thin film composite (TFC) membrane is in the form of hollow fibers, flat sheets, tubes.

10. A method of making a chemically cross-linked rubbery polymeric thin film composite (TFC) membrane comprising a selective layer of a chemically cross-linked rubbery polymer supported by a porous support membrane formed from a glassy polymer, said method comprising:
(a) preparing the porous support membrane using a phase inversion process by casting a glassy polymer solution using a casting knife;
(b) forming the chemically cross-linked rubbery polymer on the porous support membrane by
(i) applying a dilute hydrocarbon solution of a mixture of a solvent, an isocyanate functional polysiloxane and an amino functional cross-linking agent, or a mixture of a solvent, an epoxy functional polysiloxane and an amino functional cross-linking agent, or a mixture of a solvent, an amino functional polysiloxane and an isocyanate functional cross-linking agent to the top surface of the porous support membrane;
(ii) evaporating the solvent; and
(iii) heating at 70-150° C. for a period of time.

11. The method of claim 10 wherein the solvent is selected from the group consisting of n-heptane, n-hexane, n-octane, and mixtures thereof.

12. The method of claim 10 wherein:
(a) the isocyanate functional polysiloxane is an isocyanate-terminated polyorganosiloxanes;
(b) the amine functional polysiloxane is an amine-terminated polyorganosiloxane, or an aminoorganomethylsiloxane-dimethylsiloxane copolymer, or a mixture thereof;
(c) the epoxy functional polysiloxane is an epoxy-terminated polyorganosiloxane, or an epoxycyclohexylmethylsiloxane-dimethylsiloxane copolymer, or a mixture thereof;
(d) the amino functional cross-linking agent is an amine functional polysiloxane; or diamino organo silicone; and
(e) the isocyanate functional cross-linking agent is isocyanate-terminated polydimethylsiloxane, tolylene-2,4-diisothiocyanate, tolylene-2,6-diisothiocyanate, tolylene-2,4-diisocyanate, tolylene-2,5-diisocyanate, tolylene-2,6-diisocyanate, tolylene-α,4-diisocyanate, 4,4′-methylenebis(phenyl isocyanate), 1,3-phenylene diisocyanate, hexamethylene diisocyanate, 1,4-phenylene diisocyanate, or mixtures thereof.

13. The method of claim 10 wherein the isocyanate functional polysiloxane, the amino functional cross-linking agent, the epoxy functional polysiloxane, the amino functional polysiloxane, and the isocyanate functional cross-linking agent are diluted in a hydrocarbon organic solvent in a concentration of from about 1 to about 20 wt. %.

14. The method of claim 10 wherein the glassy polymer solution comprises NMP, 1,3-dioxolane, glycerol, and n-decane.

15. The method of claim 10 wherein the applying the dilute hydrocarbon solution to the top surface of the porous support membrane is by dip-coating, spin coating, casting, soaking, spraying, or painting.

16. The method of claim 10 wherein the heating at 70-150° C. is for 2 min to 120 min.

17. A process for removing at least one component from a stream comprising contracting the stream with a chemically cross-linked rubbery polymeric thin film composite (TFC) membrane comprising a selective layer of a chemically cross-linked rubbery polymer supported by a porous support membrane formed from a glassy polymer.

18. The process of claim 17 wherein the at least one component is nitrogen, or hydrogen, or methane.

19. The process of claim 17 wherein the stream is natural gas, fuel gas, an olefin recovery stream from a polyolefin production process, LPG, and a natural gas dew point control stream.

20. The process of claim 17 wherein the process is a step of an olefin recovery operation, a nitrogen recovery operation, an LPG recovery operation, a fuel gas conditioning operation, or a nitrogen removal from natural gas operation.

21. The process of claim 17 wherein the process is a two-stage process further comprising a glassy polymeric membrane.
